(19) United States
(12) Patent Application Publication
(10) Pub. No.: US 2026/0229553 A1
(43) Pub. Date: Aug. 6, 2026

(54) METHOD FOR MANUFACTURING METAL CATALYST-SUPPORTING CARBON MATERIAL

(71) Applicant: TOYO UNIVERSITY, Tokyo (JP)

(72) Inventor: Mika GAMO, Kawagoe-shi (JP)

(73) Assignee: TOYO UNIVERSITY, Tokyo (JP)

(21) Appl. No.: 19/149,892

(22) PCT Filed: Jan. 23, 2024
(86) PCT No.: PCT/JP2024/001736

§ 371 Date: Jul. 22, 2025

(30) Foreign Application Priority Data
Jan. 24, 2023 (JP) 2023-008881

(51) Int. Cl. H01M 4/90; C01B 32/162; D06M 11/84; D06M 23/10; D06M 101/40; H01M 4/92

(52) U.S. Cl. CPC H01M 4/9083; C01B 32/162; D06M 11/84; D06M 23/10; H01M 4/926; C01B 2202/22; C01P 2004/03; C01P 2004/04; C01P 2004/13; C01P 2006/40; D06M 2101/40

(57) ABSTRACT

A carbon material supporting a metal catalyst in a unique support conformation is provided. The method for supporting a metal catalyst on a surface of a carbon fiber comprises: a) a step of soaking the carbon fiber in a ketone solvent based or ether solvent based solution containing a compound comprising a platinum-group catalyst metal ion; and b) a step of subjecting the carbon fiber which has been taken out of the ketone solvent based or ether solvent based solution of step (a) to a heat treatment at 200 to 600° C.

### TECHNICAL FIELD

The present disclosure relates to metal catalyst-supporting carbon materials. The metal catalyst-supporting carbon materials may find diverse uses, including electrodes for fuel cells.

### BACKGROUND ART

Carbon materials have favorable electrical conductivity and thermal conductivity as well as high capacity as carriers for supporting metal catalysts. Therefore, combinations of carbon materials and metal catalysts supported thereon have been tried for a variety of industrial applications and put into practical uses. A representative example of such industrial applications is the use in the electrodes for fuel cells (especially polymer electrolyte fuel cells).

The current mainstream fuel cell electrodes have the electrode catalyst layers comprising carbon particles, such as carbon black, supporting catalyst particles such as platinum, that is, catalyst-supporting carbon particles. The carbon particles typically have particle sizes in the nanometer range such as 10 to 100 nm. A population of this catalyst-supporting carbon particle is mixed with a proton-conducting material (such as an ionomer) to form an electrode catalyst layer, one face of which contacts the electrolyte membrane (polymer electrolyte membrane) and the other face contacts the gas diffusion layer. Typically, first gas diffusion layer-first electrode catalyst layer electrolyte membrane-second electrode catalyst layer-second gas diffusion layer are stacked in this order to form a Membrane Electrode Assembly (MEA), which provides the heart of the fuel cell. Hydrogen gas as a fuel is provided to the first gas diffusion layer side, and the hydrogen is split into protons and electrons at the first electrode catalyst layer to generate electricity. Oxygen (which may be provided in the form of an air comprising the oxygen) is provided to the second gas diffusion layer side. At the second electrode catalyst layer, the oxygen is subject to a redox reaction involving the protons which have passed through the electrolyte membrane and the electrons which have travelled through the external conducting wire, to form water molecules. The first electrode catalyst layer may be referred to as an anode or a fuel electrode, and the second electrode catalyst layer may be referred to as a cathode or an air electrode. The expressions such as “first” and “second” herein are used merely for the convenience of distinguishing the two sides of the electrolyte membrane from each other, and therefore the terms “first” and “second” may be interchanged in the above descriptions.

The fuel cell electrodes based on the catalyst-supporting carbon particles have been perceived as having the problem of high electrical resistance and reduced power generation efficiency due to the small areas of contact between the electrically conductive carrier particles. To address this problem, Patent Document 1 discloses an electrode for a fuel cell, comprising a current collector comprising an electrically conductive porous body and a catalyst layer, the catalyst layer consisting of: carbon nanofibers, wherein 50% or more of the tips of the carbon nanofibers are oriented at an angle of 45° or greater with respect to the face of the current collector; electrode catalyst particles supported on the surface of the carbon nanofibers; and a proton conductor formed on the surface of the carbon nanofibers in contact with the electrode catalyst particles. The electrically conductive porous body in Patent Document 1 is for example a carbon cloth, a carbon paper (i.e. carbon fiber paper) or the like. Patent Document 1 discloses a process for supporting the platinum catalysts on the carbon nanofibers grown on the carbon paper, the process comprising the following steps: using the sputtering method to make a film of Ni, as a catalyst for producing carbon nanofibers, on one face of the carbon paper; allowing carbon nanofibers to grow from there by a thermal CVD method; soaking this sample in an aqueous solution of chloroplatinic acid followed by dropwise addition of an alkali aqueous solution of sodium hydrogen carbonate to induce deposition of platinum hydroxide fine particles, which are finally reduced by hydrogen.

Patent Document 2 discloses an electrode catalyst layer for fuel cell, comprising: electrically conductive fibers which carry electrically conductive nanofibers; catalyst particles supported on at least the electrically conductive nanofibers; and solid polymer electrolyte. Similar to that of Patent Document 1, the fuel cell electrode of Patent Document 2 which is based on electrically conductive fibers (carbon fibers) and electrically conductive nanofibers (carbon nanofibers) can provide the gaps through which gas and liquid can be diffused or transported while securing the continuous paths for electron conduction by the carbon fibers, at least partially overcoming the shortcomings of the carbon particle support-based fuel cell electrodes. Patent Document 2 discloses a process for supporting the platinum particles on the carbon fibers and the carbon nanotubes, the process comprising the following steps: producing a film of iron on the surface of the carbon fibers by a sputtering method; allowing carbon nanotubes to grow from there by a thermal CVD method; soaking this sample in an aqueous solution of diamminedinitritoplatinum followed by addition of ethanol as a reductant. Patent Document 2 further discloses that the carbon fibers, on the surface of which the carbon nanotubes had been grown and the platinum particles had been supported, were twined and plainly woven to produce a platinum-supporting carbon cloth, which was used as a material for the electrode catalyst layer of the fuel cell.

As illustrated in Patent Documents 1 and 2, the fuel cell electrodes which are based on sheet-like porous carbon materials, such as carbon cloths and carbon papers, can also play the role of a gas diffusion layer.

Patent Document 3 discloses a process for supporting platinum fine particles on the carbon nanofilaments of the marimo (moss ball) carbon by a nano-colloid method. The marimo carbon is a material obtained by allowing carbon nanofilaments to grow radially from the nucleus of a diamond fine particle. The nano-colloid method described by Patent Document 3 appears to involve soaking a marimo carbon in an aqueous solution of chloroplatinic acid and citric acid followed by reduction by sodium borohydride to induce deposition of platinum.

Patent Document 4 discloses that the composition comprising palladium (which comprises palladium oxide and palladium metal) deposited by sputtering on the surface of a carbon fiber of carbon paper can provide a hydrogen sensor. This hydrogen sensor makes use of the heat generated by palladium when it occludes hydrogen and the high thermal conductivity of carbon. Patent Document 4 represents an example showing that a combination of a carbon material and a metal catalyst supported thereon can find diverse applications beyond fuel cell electrodes.

### CITATION LIST

### Patent Documents

Patent Document 1: JP 2002-298861 A
Patent Document 2: JP 2006-216385 A
Patent Document 3: JP 2013-47160 A
Patent Document 4: JP 2021-014610 A

### SUMMARY OF THE INVENTION

Different conformations by which catalyst metals are supported on the surface of carbon materials, together with variation in the forms of the carbon materials themselves, may produce industrially useful new properties. The present inventor has discovered that conformations of catalyst metals being supported on carbon materials can be significantly modified by using different solvents when the carbon materials are soaked in the solutions of the catalyst metals, and that markedly unique metal-supporting conformations can be obtained on carbon materials by using certain specific solvents. The embodiments of the present disclosure are based on these discoveries.

The present disclosure includes the following embodiments.
[1] A method for supporting a metal catalyst on a surface of a carbon fiber, the method comprising:
a) a step of soaking the carbon fiber in a ketone solvent based or ether solvent based solution containing a compound comprising a platinum-group catalyst metal ion; and
b) a step of subjecting the carbon fiber which has been taken out of the ketone solvent based or ether solvent based solution of step (a) to a heat treatment at 200 to 600° C.
[2] The method according to [1], wherein the ketone compound constituting the ketone solvent is represented by the formula R¹—C(═O)—R² wherein R¹ and R² are each independently an alkyl of 4 or fewer carbons, and the ether compound constituting the ether solvent is represented by the formula R³—O—R⁴ wherein R³ and R⁴ are each independently an alkyl of 4 or fewer carbons, wherein each of the alkyls is substituted or unsubstituted.
[3] The method according to [1] or [2], wherein the platinum-group catalyst metal is selected from the group consisting of palladium, platinum, ruthenium, rhodium, iridium, osmium, and any combination thereof.
[4] The method according to any one of [1] to [3], wherein the compound comprising the platinum-group catalyst metal ion is palladium(II) acetate.
[5] The method according to any one of [1] to [4], wherein the heat treatment is performed under an inert gas atmosphere.
[6] The method according to any one of [1] to [5], wherein the carbon fiber is a carbon nanofilament having a cup-stacked structure or a coin-stacked structure.
[7] The method according to any one of [1] to [6], wherein the carbon fiber is a carbon nanofilament grown on a surface of a different carbon fiber.
[8] The method according to any one of [1] to [7], wherein the carbon fiber or the different carbon fiber forms a carbon fiber paper or a carbon cloth.
[9] The method according to any one of [1] to [8], further comprising, prior to step (a),
supporting a nickel catalyst precursor on a surface of a carbon fiber of a carbon fiber paper or a carbon cloth by soaking the carbon fiber paper or carbon cloth in an ethanol solution containing nickel nitrate;
placing the carbon fiber paper or carbon cloth, which has been taken out of the ethanol solution, under a temperature of 350 to 450° C. to perform annealing of the nickel catalyst; and
subjecting the post-annealing carbon fiber paper or carbon cloth to a contact reaction with a hydrocarbon gas at a temperature of 400 to 600° C. to induce a carbon nanofilament to grow from the nickel catalyst,
wherein the platinum-group catalyst metal is supported via steps (a) and (b) on:
i) a surface of the carbon nanofilament; or
ii) a surface of the carbon nanofilament and a surface of a carbon fiber of the carbon fiber paper or the carbon cloth.
[10] The method according to [9], wherein the annealing is performed under an inert gas atmosphere.

### BRIEF DESCRIPTIONS OF THE FIGURES

FIG. 1 shows SEM images of a CFP (a, b) and Ni/CFPs prepared using different solvents (c-e). The magnification is 500 folds for panel (a) and 100,000 folds for the other panels as shown at the bottom of each image. c and d show partially enlarged views on the left.

FIG. 2 a to c show SEM images of the CNFs/CFPs which were produced by synthesizing CNFs from the Ni/CFPs corresponding to FIG. 1c to e. FIG. 2d shows a TEM image of a single fiber in the CNFs of (b) which was derived from the Ni/CFP prepared by using an ethanol solvent. The angles of the stacked graphene sheets are indicated by the added lines.

FIG. 3 shows SEM images of the carbon fibers of the CFP (a) and the cup-stacked CNFs (b) which were manipulated to support palladium by using an acetone solution of palladium acetate.

FIG. 4 shows SEM images of the cup-stacked CNFs manipulated to support palladium by using an aqueous solution (a) or diethyl ether solution (b) of palladium acetate.

FIG. 5 shows SEM images of the CNFs manipulated to support palladium by using a diacetone alcohol solution of palladium acetate.

### DETAILED DESCRIPTION OF THE INVENTION

In one aspect, the present disclosure provides a method for supporting a metal catalyst on a surface of a carbon fiber. Various carbon fibers are known to those skilled in the art, including the carbon fibers made from carbonization of organic polymer fibers or melt-spun pitch as well as the carbon nanofibers synthesized by chemical vapor synthesis. A carbon fiber typically comprises 85% by mass or more of carbon, and may comprise 90% by mass or more, or 99% by mass or more, of carbon. The carbon fiber (single fiber) preferably has a diameter in the micrometer to nanometer range. The diameter of the carbon fiber may be for example within a range of 5 nm to 100 μm, or 10 nm to 10 μm. Diameters of the carbon fibers may be measured by an electron microscope as known to those skilled in the art. Diameters of the carbon fibers may be determined according to JIS R7607:2000. The carbon fibers may be provided in an intertwined, interwoven, interlaced, or otherwise interconnected form, and may be provided as part of a composite material in which they are combined with other material(s). A carbon fiber paper and a carbon cloth may for example comprise on the fiber surface a small amount of a binder or residue thereof to bond the carbon fibers together.

The metal catalyst, which is supported on the surface of the carbon fiber in the present embodiments, is more specifically a catalyst based on a platinum-group metal. In one embodiment the method comprises step (a) of soaking the carbon fiber in a ketone solvent based solution containing a compound comprising an ion of a platinum-group catalyst metal. The platinum-group catalyst metal in the present embodiments may be selected from the group consisting of palladium, platinum, ruthenium, rhodium, iridium, osmium, and any combination thereof. Among them, palladium and platinum are especially preferable because of their high industrial availability as well as suitability to the present methods.

The compound comprising the platinum-group catalyst metal ion may be a complex or a salt. For example, in an embodiment where the platinum-group catalyst metal is palladium, the compound comprising the platinum-group catalyst metal ion is preferably palladium(II) acetate. Other examples of the compound comprising palladium ion include, but are not limited to, palladium(II) chloride, palladium(II) bromide, palladium(II) nitrate, palladium(II) sulfate, and diamminedichloropalladium(II). Examples of the compound comprising platinum ion include, but are not limited to, hexachloroplatinic(IV) acid (e.g. as a hexahydrate), tetraammineplatinum(II) nitrate, hexaammineplatinum(IV), and tetraammineplatinum(II) hydroxide (e.g. as a hydrate).

One of the features of the present embodiment is that it uses a solution of the compound comprising the platinum-group catalyst metal ion dissolved in a ketone solvent. This feature can contribute to the markedly unique metal-supporting conformations. The ketone compound constituting the ketone solvent may be represented by the structural formula R¹—C(═O)—R², wherein R¹ and R² may be each independently an alkyl of 4 or fewer carbons. The alkyl in the present disclosure may be an unsubstituted alkyl or a substituted alkyl, and may be for example substituted with a hydroxyl group. Preferably R¹ and R² are each independently an alkyl of 2 or fewer carbons. The ketone solvent may be for example acetone, methyl ethyl ketone, diethyl ketone, diisobutyl ketone, methyl isobutyl ketone, diacetone alcohol, or any combination thereof. Acetone, methyl ethyl ketone, diacetone alcohol, or a combination thereof is more preferable, and acetone is still more preferable. A ketone solvent in the present disclosure means a solvent whose predominant constituent in terms of mass is a ketonic solvent (which can for example account for 90% by mass or more, 95% by mass or more, or 100% by mass of the ketone solvent). A suitable concentration of the platinum-group compound in the ketone solvent based solution can be determined by a person skilled in the art as needed, and it may be for example within a range of 0.1 to 5% by mass or 0.5 to 2% by mass. The amount of the catalyst supported can be modulated by changing the concentration or time for the soaking (the same can be said for the nickel catalyst described below). In any case, a difference in the conformation by which the metal catalyst particles are supported can be confirmed in comparison to when the compound is dissolved at the same concentration but in a different type of solvent.

It is believed that when the carbon fibers are soaked in the ketone solvent based solution, the platinum-group catalyst metals or ions thereof or the compounds comprising them (which may be also called catalyst precursors) are adsorbed to the surface of the carbon fibers. The time length for the step of soaking is not particularly limited and may be for example within a range of 1 minute to 72 hours, typically 10 minutes to 24 hours, more typically 30 minutes to 60 minutes. If the carbon fibers form a material having gaps or porosity such as a carbon fiber paper and carbon cloth described below, the step of soaking may be also referred to as a step of “impregnation.”

In step (b), the carbon fiber which has been taken out of the ketone solvent based solution of step (a) is subjected to a heat treatment at 200 to 600° C. The temperature of the heat treatment may be 220 to 400° C., or 250 to 300° C. This heat treatment step is believed to cause the catalyst metal to become particles and settle in a fixed distribution on the surface of the carbon fibers, and to also cause decomposition/removal of the non-metal components. In some embodiments, the heat treatment step is performed under an inert gas atmosphere. Examples of the inert gas include, but are not limited to, argon and nitrogen. The atmosphere for the heat treatment preferably consists only of inert gas. In certain embodiments, the atmosphere for the heat treatment does not contain a reductive gas such as hydrogen. In certain other embodiments, the atmosphere for the heat treatment may contain a reductive gas such as hydrogen (e.g. in mixture with an inert gas). In certain embodiments, the method does not comprise a separate reducing step and/or neutralizing step in addition to the steps described herein. For example, in some embodiments, the ketone solvent based solution does not receive a reducing treatment and/or neutralizing treatment following the step of soaking.

A step of drying the carbon fiber which has been taken out of the ketone solvent based solution of step (a) may be inserted before step (b) or as part of step (b). This can remove any residual ketone solvent based solution which accompanied the carbon fibers when they were taken out of the ketone solvent based solution. For example, the carbon fibers may be dried in the air at room temperature or at 250 to 400° C., separate from the step of heat treatment (b) performed under the inert gas atmosphere. The step of drying may be performed for example for 30 to 90 minutes. A set of steps, of soaking the carbon fiber in the ketone solvent based solution and of drying it, may be repeated to carry out two or more sets.

In another aspect, an ether solvent is used instead of the ketone solvent in the descriptions provided above. When the ketone solvent was replaced by the ether solvent in the embodiments described above, the density, or the amount, of the supported platinum-group metal catalyst particles appeared to be reduced, but markedly diminutive particles unique to the use of the ether solvent could be obtained. Applications which take advantage of the modulated catalytic activity due to the extremely diminutive catalytic particles can be contemplated. The ether compound constituting the ether solvent herein may be represented by the structural formula R³—O—R⁴, wherein R³ and R⁴ may be each independently an alkyl of 4 or fewer carbons. Preferably R³ and R⁴ are each independently an alkyl of 2 or fewer carbons. The ether solvent may be for example diethyl ether, dimethyl ether, ethyl methyl ether, or any combination thereof. An ether solvent in the present disclosure means a solvent whose predominant constituent in terms of mass is an etheric solvent (which can for example account for 90% by mass or more, 95% by mass or more, or 100% by mass of the ether solvent). For the materials other than the solvent as well as for the method procedures, the same descriptions as provided above in relation to the ketone-solvent-based methods may be similarly applicable.

The carbon fiber in the present embodiments is preferably a carbon nanofilament having a cup-stacked or coin-stacked structure, more preferably a carbon nanofilament having a cup-stacked structure. The term cup-stacked structure is used to refer to a carbon nanofilament formed by graphene sheets which are stacked up with one another and each of which has a cup-like or cone-like three-dimensional shape sloped towards the center rather than being planar. The term coin-stacked structure is used to refer to a carbon nanofilament formed by pieces of graphene sheets which are stacked up with one another and each of which is planar (coin-like) rather than a cup-like or cone-like three-dimensional shape. However, even if the word “coin” is used to describe it, it does not mean that the pieces of graphene sheets are necessarily round. The cross sections of these carbon nanofilaments may have various irregular shapes. The cross sections of these carbon nanofilaments may have a hole in the center (i.e., the carbon nanofilaments may be tubular).

The cup-stacked structures and the coin-stacked structures are known, and disclosed for example by Patent Document 3 as constituents of the marimo carbons. Also, a population of carbon nanofilaments having particularly preferable cup-stacked structures can be obtained by the method comprising a step of soaking a carbon fiber paper or carbon cloth in an ethanol solution, as described herein below. The slope angle of the graphene sheet towards the center can be defined as 180° for a coin-stacked structure, and by this definition, for a cup-stacked structure, it is preferably 135° or smaller, more preferably 90° or smaller, and especially preferably 45° or smaller. The angle of the graphene sheets in a cup-stacked structure is typically no smaller than 10°. The diameter of a carbon nanofilament may be for example 5 to 500 nm, 5 to 300 nm, 10 to 100 nm, or 10 to 50 nm.

The carbon nanofilament which may have a cup-stacked or coin-stacked structure is distinct from a carbon nanotube which consists of a graphene sheet itself rolled up to form a tube. Unlike the carbon nanotube, the carbon nanofilament which may have a cup-stacked or coin-stacked structure is characterized by having many edges of graphene exposed on the fiber surface. It was appreciated already in the past that such graphene edges were suitable for providing the sites for supporting catalyst metal particles. This advantage is even more pronounced in the cup-stacked structure exposing the graphene edges with the angles compared to the coin-stacked structure. In the present disclosure, it has been discovered that the availability of the many graphene edges and the unique metal deposition mechanisms obtained by the use of the ketone solvent based solution can work synergistically to achieve a previously unseen, highly dense yet finely arranged conformation of supporting the metal catalysts. In an example of the present embodiment, the metal catalyst particles deposited from the ketone solvent based solution on the cup-stacked type carbon nanofilaments exhibited dispersion uniformity and density similar to those on a carbon fiber not having a cup-stacked structure (i.e. the fiber of the carbon fiber paper) treated under the same condition, but the former had particle sizes which were at least several times to tens of times smaller. Thus, the increased catalyst density was achieved while preserving the high degrees of porousness of the carbon nanofilaments. In the use for the fuel cell electrodes, for example, preserving the porousness to the maximum extent represents a great advantage because there is a need for ensuring diffusion of the fuel gas and draining of the produced water.

It was conventionally conceivable to deposit a metal from a metal salt with the use of a neutralizing or reducing agent, or by sputtering, on minute structures such as a population of carbon nanofilaments. However, in these cases, fine control of amount and form of deposition was difficult, and excessive deposition and considerably spotty distribution of the metal disposition sites in the whole of the carbon nanofilament population were likely possibilities. In the present embodiment using the ketone solvent based solution, it is possible to disperse fine platinum-group catalyst metal particles evenly and at a high density on individual carbon nanofilaments in the population while preserving the advantageous porousness of the carbon nanofilaments.

The carbon nanofilament in one embodiment may be a carbon nanofilament which constitutes a marimo carbon. In another embodiment, the carbon nanofilament (especially that having a cup-stacked or coin-stacked structure) may be a carbon nanofilament grown from a surface of a different carbon fiber. The different carbon fiber in this case is typically thicker than the carbon nanofilament and may for example have a diameter of 1 μm or greater. In other words, the carbon nanofilament may be attached to the surface of a carbon microfiber which is thicker than the carbon nanofilament. The diameter of this carbon microfiber is not particularly limited and may be for example no greater than 100 μm or no greater than 10 μm.

For example, this different carbon fiber thicker than the carbon nanofilament may be a carbon fiber forming a carbon fiber paper (CFP) or a carbon cloth. An especially preferable method for producing carbon nanofilaments for such embodiments are disclosed in the present specification. In a carbon cloth, the carbon fibers are woven as in a cloth. In contrast, in a carbon fiber paper, the carbon fibers are not woven but associated with each other in a relatively irregular manner to form a sheet-like material as a whole. In that sense, for the purpose of the present disclosure, carbon fiber nonwoven fabrics, carbon felts and the likes may be included in carbon fiber papers. Many carbon fiber papers and carbon cloths are known to those skilled in the art and are suitable in the present embodiments. Carbon fiber papers and carbon cloths may be composite materials also containing materials other than pure carbon.

In some embodiments, the present disclosure provides a method comprising the following steps:
supporting a nickel catalyst precursor on a surface of a carbon fiber of a carbon fiber paper or a carbon cloth by soaking the carbon fiber paper or carbon cloth in an ethanol solution containing nickel nitrate;
placing the carbon fiber paper or carbon cloth, which has been taken out of the ethanol solution, under a temperature of 350 to 450° C. to perform annealing of the nickel catalyst; and
subjecting the post-annealing carbon fiber paper or carbon cloth to a contact reaction with a hydrocarbon gas at a temperature of 400 to 600° C. to induce a carbon nanofilament to grow from the nickel catalyst.

These steps may be performed independently as a method for producing a carbon nanofilament having a cup-stacked structure. Alternatively, these steps may be performed prior to the step (a) of soaking the carbon fiber in the ketone solvent (or ether solvent) based solution described above. In that case, in the subsequent steps (a) to (b), the platinum-group catalyst metal will be supported on:
i) a surface of the carbon nanofilament; or
ii) a surface of the carbon nanofilament and a surface of a carbon fiber of the carbon fiber paper or the carbon cloth.

The term catalyst precursor as used in the present disclosure refers to where the catalyst metal has been supported by the carbon fiber but is still to receive final annealing. The term does not necessarily exclude the possibility that the supported catalyst precursor itself has a catalytic activity. During the treatment of the nickel catalyst precursor in the high temperature, it is annealed while it becomes a nickel catalyst, thereby preparing the condition in which the nickel catalyst that will be directly involved in the final carbon nanofilament production has been supported on the carbon fiber surface.

A reason this embodiment is especially preferable is because it can produce an advantageous population of carbon nanofilaments having minute diameters generally in the range of tens of nanometers and intertwined innumerably (thus simultaneously achieving a markedly large surface area, porousness, and contiguous electrical conductivity), as well as because it can produce the carbon nanofilaments in cup-stacked structures desirable for supporting the catalysts, and furthermore it can provide the unique effect of depositing the platinum-group catalyst metal particles from the ketone solvent based solution (which can synergistically attain further uniqueness in the increased minuteness of the particles) evenly on the surface of individual filaments while preserving the overall shape of the advantageous population of carbon nanofilaments.

The growth of the carbon nanofilaments having the combination of ideal distribution and cup-stacking seems to have stemmed from the support condition of nickel specifically obtained by use of the combination of nickel nitrate and ethanol against the fibers of carbon fiber paper or the like. Without wishing to be bound by any theory, it appears that an ethanol solution of nickel nitrate can cause unique interactions on the surface of the fibers of carbon fiber paper or the like, or possibly even surface erosion to a degree, to allow deposition of densely yet uniformly dispersed nickel fine particles with diameters of about several nanometers to several tens of nanometers. Further, it is believed that the deposition configuration, and/or decomposition of the nitrate during the subsequent annealing treatment, will provide and/or maintain the ability of the nickel particle catalysts to generate cup-stacking. The concentration of nickel nitrate in the ethanol solution may be for example 0.01 to 1 mol/L or 0.05 to 0.5 mol/L. Differences in the support condition and in the carbon nanofilaments can be observed in comparison to when a solution with a different solvent or with a different compound at the same concentration is used.

The term ethanol solution herein refers to a solution whose solvent consists substantially of ethanol and has a water content of less than 10% by mass. Preferably, the water content of the ethanol solution is no higher than 5% by mass or no higher than 3% by mass. As known to those skilled in the art, even an anhydrous ethanol usually inevitably contains a trace amount of water. Furthermore, when a hydrate of nickel nitrate (Ni(NO₃)₂·6H₂O) is dissolved, the solution will also comprise the water originating from the hydrate crystal. Therefore, a water content of less than 10% by mass is permitted in the ethanol solution of nickel nitrate in the present embodiments. When water exceeding this amount is added, or when an aqueous solution of nickel nitrate is used, one or more of the properties obtained with the ethanol solution, including evenness of the distribution and evenness of the size of the nickel particles, the density, the amount of carbon nanofilaments produced, and cup-stacking of the carbon nanofilaments, may be significantly lost.

The time for soaking the carbon fiber paper or carbon cloth in the ethanol solution is not particularly limited, and it may be for example within a range of 1 minute to 72 hours, typically 10 minutes to 24 hours, and more typically 30 to 90 minutes.

The annealing treatment may be performed under an inert gas atmosphere. Examples of the inert gas include, but are not limited to, argon and nitrogen. The atmosphere for the annealing treatment preferably consists solely of inert gas.

Drying of the carbon fiber paper or carbon cloth which has been taken out of the ethanol solution may be inserted before the annealing. This can remove any residual ethanol solution which accompanied the carbon fibers when they were taken out of the ethanol solution. For example, the carbon fiber paper or carbon cloth may be dried in the air at room temperature or at 300 to 400° C., separate from the annealing treatment performed under the inert gas atmosphere. Drying may be performed for example for 30 to 90 minutes. A set of steps, of soaking the carbon fiber paper or carbon cloth in the ethanol solution and of drying it, may be repeated to carry out two or more sets.

Subjecting the post-annealing carbon fiber paper or carbon cloth to a contact reaction with a hydrocarbon gas will induce carbon nanofilaments to grow from the supported nickel catalysts. The temperature of the contact reaction may be 400 to 600° C., preferably 450 to 550° C. The time for the reaction may be for example 30 to 180 minutes. The hydrocarbon gas may be for example methane, ethane, or a combination thereof. Diluting gas or reaction-aid gas, such as inert gas and hydrogen gas, may be added to the hydrocarbon gas as appropriate.

### EXAMPLES

Below, examples are provided to more specifically describe some embodiments. However, these examples describe representative experiments merely for the illustrative purposes, and embodiments of the invention are not limited to these examples.

### Reference Example: Synthesis of Carbon Nanofilaments (CNFs) on a Carbon Fiber Paper (CFP)

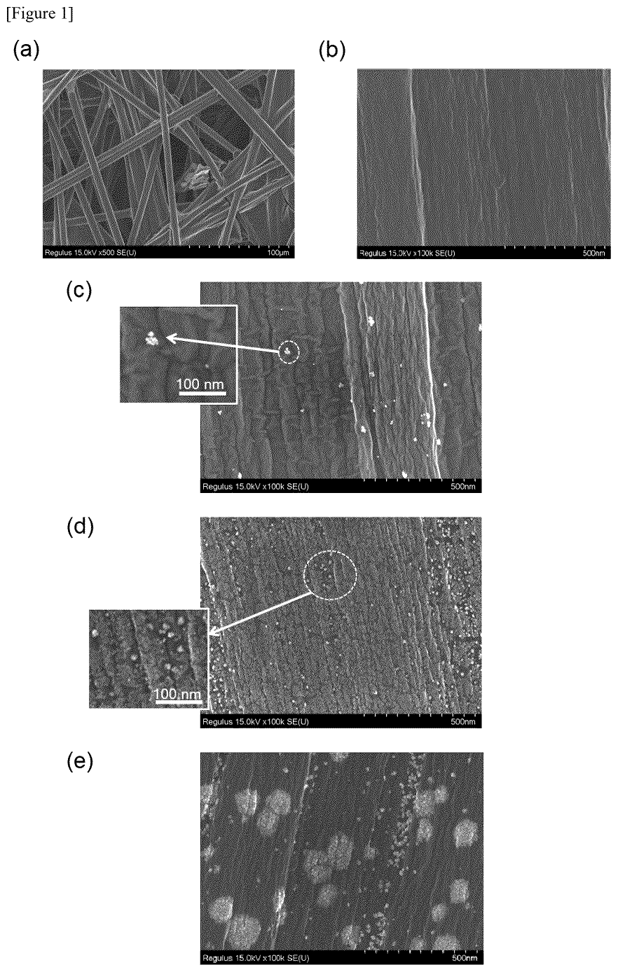

As shown in the scanning electron microscope (SEM) image of FIG. 1a, the CFP (Toray Industries, TGP-H-060 (0.19 mm thick) or TGP-H-120 (0.37 mm thick)) is a sheet-like porous material formed by numerous carbon fibers bound to each other, the average diameter of individual fibers being about 6 μm. As a pretreatment, the CFP was heat-treated in the air at 350° C. for 30 minutes. The CFP was cut into 1 cm×3 cm sized pieces which were used in the following experiments.

To prepare a nickel (Ni) catalyst precursor supported on the surface of the carbon fibers of the CFP, the CFP was impregnated with the solution containing nickel nitrate hydrate (Ni(NO₃)₂·6H₂O) dissolved in anhydrous ethanol, pure water, or a 30% (v/v) ethanol aqueous solution. The concentration of nickel was 0.0860 mol/L in each case. In the case of pure water, the CFP floated on the water surface, and therefore the CFP was first caused to sink by sonication before it was impregnated. When anhydrous ethanol was used, the water content of the solvent was calculated to be about 1.7% (v/v) taking into account the water originating from the nickel nitrate hydrate. After 30 minutes of impregnation, the CFPs were taken out of the solutions and dried in the air at 350° C. for 60 minutes. It was believed that the nitrate ions from the impregnation solution were also decomposed and removed during this. A set of impregnating and drying was repeated once, but in the second impregnation step, the CFP was turned upside-down compared to the first time. Next, the sample was introduced to a fixed-bed flow reactor and an annealing treatment was performed under an argon (Ar) gas atmosphere (30 sccm) at 400° C. for 60 minutes to produce extremely fine Ni catalyst particles. By following these procedures, the CFP supporting the Ni catalyst (called Ni/CFP) was obtained.

FIG. 1b to e provide SEM images capturing the carbon fiber surfaces of a CFP (b) and Ni/CFPs (c to e) and the Ni particles supported thereon. When Ni was deposited and supported from a pure water solution of nickel nitrate, the particles were characterized by considerable unevenness in the supporting, such as aggregations of particles in a few sites on one hand and sparsely distributed particles in the remaining wide areas on the other hand (FIG. 1c). In contrast, when Ni was deposited and supported from an ethanol solution of nickel nitrate, fine particles were well-dispersed on the carbon fiber surface with significantly high evenness (FIG. 1d). On the SEM image, it appeared that minute pits of the size which could accommodate individual fine particles were formed on the carbon fiber surface and the dispersed fine particles were fitted in these pits (partially enlarged view on the left of FIG. 1d). Adding even a relatively small amount of water to ethanol, such that the water content of the solution exceeded 10% by mass, resulted in observable unevenness in the supporting (FIG. 1e).

For another set of samples, the temperature inside the reactor was raised from the temperature of the annealing treatment to 500° C. (20° C./min), and as soon as the temperature reached 500° C., Ar gas was switched to CH₄ hydrocarbon gas (30 sccm) to perform a contact reaction for 60 minutes. At this time, numerous carbon nanofilaments (CNFs) grew from the Ni catalyst support sites by chemical vapor synthesis on the carbon fiber surface of the CFP. The CFP covered by the CNFs thus obtained is called a CNFs/CFP. The growth states of the CNFs were significantly different depending on whether the Ni supporting had been even or not.

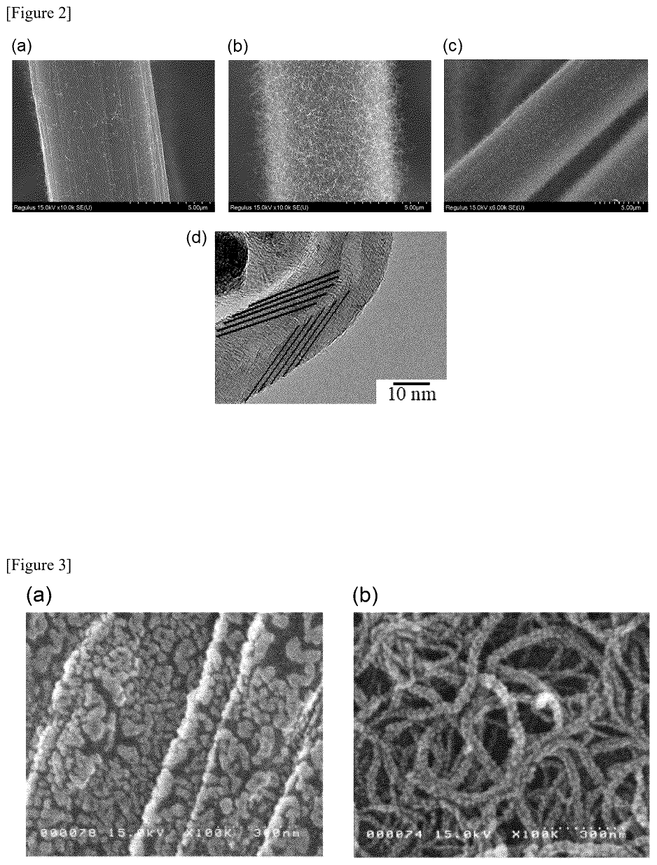

That is, in the samples which had used the anhydrous ethanol solvent in the step of impregnation with nickel nitrate, the CNFs grew at high density and high uniformity to provide a large amount of CNFs (FIG. 2b). Following the synthesis of the CNFs, an increase in the weight equivalent to about 20% of the weight of the CFP was measured, and this was assumed to be the amount of CNFs produced. In the SEM image of the cross section (not shown), it was observed that a population of CNFs formed a layer, having a thickness of about 2 μm, which covered the CFP fiber having a diameter of about 6 μm.

In comparison, in the samples which had used pure water as a solvent in the step of impregnation with nickel nitrate, the CNFs were visually sparse, with CNF yields lower by at least 25% or more (FIG. 2a). In the samples which had used an aqueous ethanol solution in the step of impregnation with nickel nitrate, the result was intermediate between those obtained with anhydrous ethanol and pure water (FIG. 2c). Also importantly, in the samples which had used the anhydrous ethanol solvent in the step of impregnation with nickel nitrate, the CNFs had clear cup-stacked structures characterized by the desirable angles, as confirmed by transmission electron microscopy (TEM) (FIG. 2d).

### Supporting Platinum-Group Catalyst Metal From a Ketone Solvent Based Solution

As described for the Reference Example above, CNFs with cup-stacked structures were synthesized on a CFP starting from an anhydrous ethanol solution of nickel nitrate hydrate. Subsequently, the CNFs/CFP as a whole was impregnated with acetone (i.e. a ketone solvent) containing palladium(II) acetate, a compound comprising a platinum-group catalyst metal (palladium (Pd)) ion.

More specifically, the acetone solution in this experiment was prepared by dissolving 100 mg of palladium acetate in 12 ml of acetone. A CFP or a CNFs/CFP cut into a one-centimeter square was soaked in 5 ml of the acetone solution. After 60 minutes, the CFP and CNFs/CFP were taken out of the solution and air-dried for 2 hours. Then, in order to induce very fine Pd particles, the samples were introduced to a fixed-bed flow reactor to perform a heat treatment (annealing) under Ar atmosphere at 250° C. for 60 minutes. No distinct step was performed to neutralize or reduce the acetone solution. The weights before the impregnation and after the impregnation/annealing were compared to determine the amount of supported palladium from the weight differential. Morphology of the post-Pd-support samples was examined by SEM.

As a result, the amount of palladium supported was determined to be 0.0232 mg per 8.2357 mg of the one-centimeter square pre-impregnation CFP (Pd amounting to 0.281% by weight of the carrier). The amount of palladium supported was determined to be 0.0918 mg per 10.3466 mg of the one-centimeter square pre-impregnation CNFs/CFP (Pd amounting to 0.879% by weight of the whole carrier, and 6.183% by weight of the CNFs portion).

As shown in the SEM images of FIG. 3, the carbon fibers of the CFP (a) and CNFs (b) each had extraordinary support conformation in which catalyst particles covered the surfaces with markedly high distribution evenness, size uniformity and density. Further, remarkably, while the carbon fiber surface of the CFP was covered by catalyst particles having diameters of mainly about 90 nm, the surface of the cup-stacked CNFs was covered by particles having diameters mainly in the range of about 5 to 20 nm, which were at least several times smaller. Therefore, the advantageous shapes and porousness of the population of the minute CNFs could be preserved.

### Comparison of the Effects of Using the Pure Water Solvent and the Ether Solvent

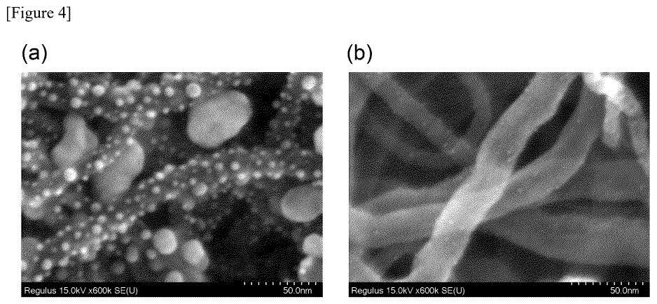

Results for the further experiments are also shown which used essentially the same conditions as above except that palladium(II) acetate was dissolved in a pure water solvent or a diethyl ether solvent instead of the ketone solvent. However, since solubility of the palladium acetate reagent (FUJIFILM Wako Pure Chemical Corporation) in water was low, the solution was warmed by using a 70° C. water bath to facilitate dissolution to achieve the highest practically possible concentration. When the pure water solvent was used, palladium showed the tendency to separate from the carbon fiber surface to swell and expand like round balloons. It also caused excessive and uneven depositions, resulting in the formation of some globs which were so large as to clog the porosity of the CNFs (FIG. 4a). It was clear that efficient use of the surface areas of both CNFs and Pd was compromised. In contrast, when the diethyl ether solvent was used, the Pd particles were obtained in extremely tiny forms which were difficult to visualize unless the magnification of SEM was increased (FIG. 4b). The amount of palladium supported per weight of the carrier in this case was smaller by at least 30% or more compared to the experiment with the acetone solvent, but still, an amount supported that could reach an equivalent of about 3% by weight of the CNFs portion could be measured. Therefore, it is possible that Pd is actually spread more broadly outside the visible dots which can be seen in the image of the CNFs provided in FIG. 4b.

### Supporting Platinum-Group Catalyst Metal From Different Ketone Solvent Based Solutions

CNFs/CFPs were synthesized in the essentially same way as Reference Example above except that the CH₄ gas flow rate was changed to 150 sccm. Further, an experiment was carried out which was essentially the same as in the section described under the title of [Supporting platinum-group catalyst metal from a ketone solvent based solution] except that diacetone alcohol, instead of acetone, was used as a ketone solvent. More specifically, 8 mg (sample 1) or 37.1 mg (sample 2) of palladium acetate was dissolved in 1 mL of diacetone alcohol, and a CNFs/CFP was impregnated with this solution. Following the impregnation, a step of drying in the air at 250° C. was performed for 15 minutes, and in total this impregnation process was carried out for 6 times (sample 1) or two times (sample 2). The samples were then heated for 1 hour in an Ar gas flow at 400° C. to provide CNFs/CFPs supporting Pd. The weights before and after the Pd supporting were compared and the amount of palladium supported was determined from the weight differential. Morphology of the post-Pd-support samples was examined by SEM.

The results showed that, before impregnation, the weights of the CNFs/CFP carriers were 10.17 mg and 10.71 mg, and the weights of the CNFs portions were 1.79 mg and 1.70 mg, for sample 1 and sample 2, respectively. In the final carriers following impregnation, the amounts of Pd supported were 0.84 mg and 1.61 mg, respectively.

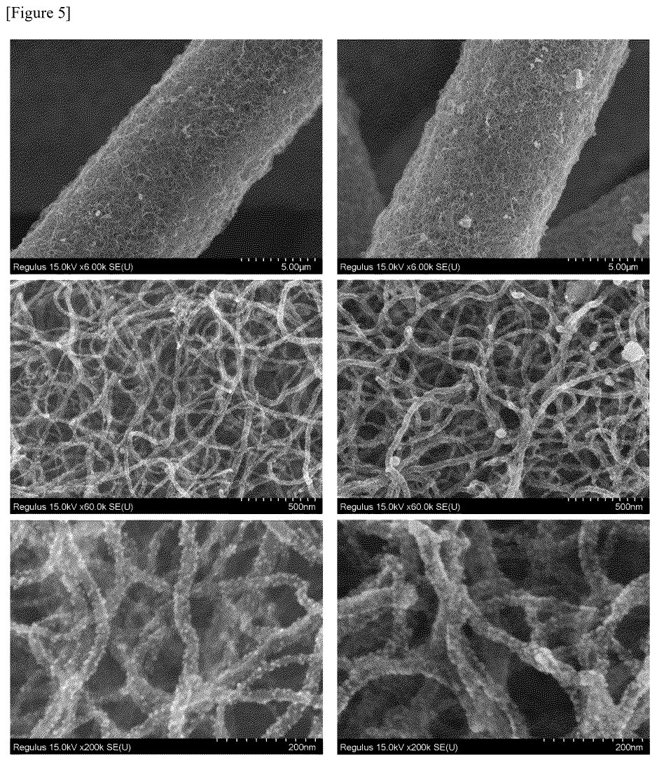

FIG. 5 shows SEM images of the Pd-supporting CNFs of sample 1 (left) and sample 2 (right). Magnifications for SEM were 6,000× (top panels), 60,000× (middle panels), and 200,000× (bottom panels). A unique support conformation in which the catalyst particles cover the surfaces at high density is observed, similar to the results of the experiments using acetone solvents. More specifically, in sample 1 (left), Pd fine particles having particle sizes of no larger than 10 nm are dispersed and supported on the surfaces of CNFs. In sample 2 (right), Pd fine particles having particle sizes of mainly between 10 and 20 nm are supported on the surfaces of CNFs in a more condensed fashion. There appears to be many instances of particles connected to each other. In both samples, Pd particles are supported as if they overlie the surfaces of the CNFs, and from the comparison between the samples, it is suggested that the supporting amounts and the particle sizes can be controlled by varying the concentrations of the Pd solutions.

1. A method for supporting a metal catalyst on a surface of a carbon fiber, the method comprising:
a) a step of soaking the carbon fiber in a ketone solvent based or ether solvent based solution containing a compound comprising a platinum-group catalyst metal ion; and
b) a step of subjecting the carbon fiber which has been taken out of the ketone solvent based or ether solvent based solution of step (a) to a heat treatment at 200 to 600°C.

2. The method according to claim 1, wherein the ketone compound constituting the ketone solvent is represented by the formula R¹—C(═O)—R² wherein R¹ and R² are each independently an alkyl of 4 or fewer carbons, and the ether compound constituting the ether solvent is represented by the formula R³—O—R⁴ wherein R³ and R⁴ are each independently an alkyl of 4 or fewer carbons, wherein each of the alkyls is substituted or unsubstituted.

3. The method according to claim 1, wherein the platinum-group catalyst metal is selected from the group consisting of palladium, platinum, ruthenium, rhodium, iridium, osmium, and any combination thereof.

4. The method according to claim 1, wherein the compound comprising the platinum-group catalyst metal ion is palladium(II) acetate.

5. The method according to claim 1, wherein the heat treatment is performed under an inert gas atmosphere.

6. The method according to claim 1, wherein the carbon fiber is a carbon nanofilament having a cup-stacked structure or a coin-stacked structure.

7. The method according to claim 6, wherein the carbon nanofilament is a carbon nanofilament grown on a surface of a different carbon fiber.

8. The method according to claim 7, wherein the different carbon fiber forms a carbon fiber paper or a carbon cloth.

9. The method according to claim 1, further comprising, prior to step (a),
supporting a nickel catalyst precursor on a surface of a carbon fiber of a carbon fiber paper or a carbon cloth by soaking the carbon fiber paper or carbon cloth in an ethanol solution containing nickel nitrate;
placing the carbon fiber paper or carbon cloth, which has been taken out of the ethanol solution, under a temperature of 350 to 450° C. to perform annealing of the nickel catalyst; and
subjecting the post-annealing carbon fiber paper or carbon cloth to a contact reaction with a hydrocarbon gas at a temperature of 400 to 600° C. to induce a carbon nanofilament to grow from the nickel catalyst,
wherein the platinum-group catalyst metal is supported via steps (a) and (b) on:
i) a surface of the carbon nanofilament; or
ii) a surface of the carbon nanofilament and a surface of a carbon fiber of the carbon fiber paper or the carbon cloth.

10. The method according to claim 9, wherein the annealing is performed under an inert gas atmosphere.
